(19) United States
(12) Patent Application Publication
(10) Pub. No.: US 2025/0031233 A1
(43) Pub. Date: Jan. 23, 2025

(54) INTERFERENCE MANAGEMENT

(71) Applicant: Nokia Technologies Oy, Espoo (FI)

(72) Inventors: Paolo BARACCA, Munich (DE); Gilberto BERARDINELLI, Aalborg (DK)

(21) Appl. No.: 18/688,154

(22) PCT Filed: Sep. 1, 2021
(86) PCT No.: PCT/EP2021/074129

§ 371 Date: Feb. 29, 2024

(51) Int. Cl. H04W 72/541; H04W 52/02

(52) U.S. Cl. CPC H04W 72/541; H04W 52/0206

(57) ABSTRACT

Various example embodiments relate to interference management in communication systems. An overlay network may transmit resource allocation messages periodically to an access point. The access point may switch to a distributed interference management mode. in response to detecting a number of consecutively lost resource allocation messages to meet a condition. Apparatuses, methods, and computer programs are disclosed.

### TECHNICAL FIELD

Various example embodiments generally relate to the field of wireless communications. Some example embodiments relate to interference management in a cellular communication network comprising local subnetworks.

### BACKGROUND

Various wireless communication systems may be configured to support local short-range subnetworks, for example to increase throughput or to reduce latency for time-critical data traffic. Examples of such local subnetworks include in-X cells envisioned for 3GPP 6G systems. One example of such a concept is a short range system like a wireless isochronous real time (WIRT) system.

6G architecture is targeted to enable easy integration of everything, i.e., a network of networks, joint communication and sensing, non-terrestrial networks and terrestrial communication, encompassing machine learning algorithms as well as local and distributed computing capabilities, where virtualized network functions can be distributed over core and edge computing resources. Far edge computing, where computing resources are pushed to the very edge of the network, will be part of the distributed computing environment, for example in “zero-delay” scenarios.

### BRIEF DESCRIPTION

Embodiments of the present disclosure enable flexible switching between centralized and distributed interference management modes.

According to a first aspect, an apparatus may comprise at least one processor and at least one memory including computer program code, the at least one memory and the computer code configured to, with the at least one processor, cause the apparatus at least to: receive a value of an interference stability metric from at least one access point; determine a condition for a number of consecutively lost resource allocation messages transmitted periodically to the at least one access point for the at least one access point to switch to a distributed interference management mode from a centralized interference management mode based on the value of the interference stability metric and a period between the resource allocation messages; and transmit an indication of the condition to the access point.

According to an embodiment of the first aspect, the condition may be inversely proportional to the period between the resource allocation messages.

According to an embodiment of the first aspect, the at least one memory and the computer code may be further configured, with the at least one processor, to cause the apparatus to: transmit an indication of a requested type of the interference stability metric to the access point.

According to an embodiment of the first aspect, the interference stability metric may be inversely proportional to a standard deviation of measured or predicted interference values over at least one period of time, or the interference stability metric may be inversely proportional to a difference between an n-th percentile and a median of the measured or predicted interference values over the at least one period of time.

According to an embodiment of the first aspect, the at least one memory and the computer code may be further configured, with the at least one processor, to cause the apparatus to: transmit the resource allocation messages periodically to the access point; and in the case a request for switching to the centralized interference management mode is received, consider whether the switching is acceptable based on a level of interference reported by the access point and/or transmission power requested by the access point.

According to an embodiment of the first aspect, the at least one memory and the computer code may be further configured, with the at least one processor, to cause the apparatus to: determine to accept the request for switching to the centralized interference mode; and transmit an acceptance message for the request for switching to the centralized interference mode to the access point.

According to an embodiment of the first aspect, in the centralized interference management mode the apparatus may be configured to perform interference management for the access point and one or more other access points, and in the distributed interference management mode the apparatus may be configured not to perform interference management for the access point and the one or more other access points.

According to an embodiment of the first aspect, the access point may be configured to provide a local subnetwork.

According to a second aspect, a method may comprise: receiving a value of an interference stability metric from at least one access point; determining a condition for a number of consecutively lost resource allocation messages transmitted periodically to the at least one access point for the at least one access point to switch to a distributed interference management mode from a centralized interference management mode based on the value of the interference stability metric and a period between the resource allocation messages; and transmitting an indication of the condition to the access point.

According to an embodiment of the second aspect, the condition may be inversely proportional to the period between the resource allocation messages.

According to an embodiment of the second aspect, the method may further comprise: transmitting an indication of a requested type of the interference stability metric to the access point.

According to an embodiment of the second aspect, the interference stability metric may be inversely proportional to a standard deviation of measured or predicted interference values over at least one period of time, or the interference stability metric may be inversely proportional to a difference between an n-th percentile and a median of the measured or predicted interference values over the at least one period of time.

According to an embodiment of the second aspect, the method may further comprise: transmitting the resource allocation messages periodically to the access point; and in the case a request for switching to the centralized interference management mode is received, considering whether the switching is acceptable based on a level of interference reported by the access point and/or transmission power requested by the access point.

According to an embodiment of the second aspect, the method may further comprise: determining to accept the request for switching to the centralized interference mode; and transmitting an acceptance message for the request for switching to the centralized interference mode to the access point.

According to an embodiment of the second aspect, the method may further comprise performing, in the centralized interference management mode, interference management for the access point and one or more other access points, and not performing, in the distributed interference management mode, interference management for the access point and the one or more other access points.

According to an embodiment of the second aspect, the access point may be configured to provide a local subnetwork.

According to a third aspect, a computer program may comprise instructions for causing an apparatus to perform at least the following: receiving a value of an interference stability metric from at least one access point; determining a condition for a number of consecutively lost resource allocation messages transmitted periodically to the at least one access point for the at least one access point to switch to a distributed interference management mode from a centralized interference management mode based on the value of the interference stability metric and a period between the resource allocation messages; and transmitting an indication of the condition to the access point. The computer program may further comprise instructions for causing the apparatus to perform any embodiment of the method of the second aspect.

According to a fourth aspect, an apparatus may comprise means for receiving a value of an interference stability metric from at least one access point; means for determining a condition for a number of consecutively lost resource allocation messages transmitted periodically to the at least one access point for the at least one access point to switch to a distributed interference management mode from a centralized interference management mode based on the value of the interference stability metric and a period between the resource allocation messages; and means for transmitting an indication of the condition to the access point. The apparatus may further comprise means for performing any embodiment of the method of the second aspect.

According to a fifth aspect, an apparatus may comprise at least one processor and at least one memory including computer program code, the at least one memory and the computer code configured to, with the at least one processor, cause the apparatus at least to: determine a condition for a number of consecutively lost resource allocation messages transmitted periodically from an overlay network; receive the resource allocation messages from the overlay network when in a centralized interference management mode; and switch to a distributed interference management mode, in response to detecting a number of consecutively lost resource allocation messages meeting the determined condition.

According to an embodiment of the fifth aspect, the at least one memory and the computer code may be further configured, with the at least one processor, to cause the apparatus to: carry out, before the switching to the distributed interference management mode, resource allocation based on a latest successfully received resource allocation message.

According to an embodiment of the fifth aspect, the at least one memory and the computer code may be further configured, with the at least one processor, to cause the apparatus to: determine a value of an interference stability metric; and determine the condition based on the value of the interference stability metric and a period of the resource allocation messages, or transmit the value of the interference stability metric to the overlay network and receive information on the condition from the overlay network.

According to an embodiment of the fifth aspect, the interference stability metric may be inversely proportional to a standard deviation of measured or predicted interference values over at least one period of time, or the interference stability metric may be inversely proportional to a difference between an n-th percentile and a median of measured or predicted interference values over at least one period of time.

According to an embodiment of the fifth aspect, the condition may be inversely proportional to the period of the resource allocation messages.

According to an embodiment of the fifth aspect, the at least one memory and the computer code may be further configured, with the at least one processor, to cause the apparatus to: transmit, to the overlay network, a request for switching to the centralized interference management mode, in response to determining that received power of at least one reference signal from the overlay network meets a second condition.

According to an embodiment of the fifth aspect, the at least one memory and the computer code may be further configured, with the at least one processor, to cause the apparatus to: switch to the centralized interference management mode, in response to receiving an acceptance message to the request for switching to the centralized interference management mode.

According to an embodiment of the fifth aspect, in the centralized interference management mode the apparatus may be configured to carry out resource allocation based on the resource allocation messages received from the overlay network, and in the distributed interference management mode the apparatus may be configured to carry out resource allocation and interference management based on local sensing on available frequency spectrum.

According to an embodiment of the fifth aspect, the apparatus may be configured to provide a local subnetwork.

According to a sixth aspect, a method may comprise: determining a condition for a number of consecutively lost resource allocation messages transmitted periodically from an overlay network; receiving the resource allocation messages from the overlay network when in a centralized interference management mode; and switching to a distributed interference management mode, in response to detecting a number of consecutively lost resource allocation messages meeting the determined condition.

According to an embodiment of the sixth aspect, the method may further comprise: carrying out, before the switching to the distributed interference management mode, resource allocation based on a latest successfully received resource allocation message.

According to an embodiment of the sixth aspect, the method may further comprise: determining a value of an interference stability metric; and determining the condition based on the value of the interference stability metric and a period of the resource allocation messages, or, transmitting the value of the interference stability metric to the overlay network and receiving information on the condition from the overlay network.

According to an embodiment of the sixth aspect, the interference stability metric may be inversely proportional to a standard deviation of measured or predicted interference values over at least one period of time, or the interference stability metric may be inversely proportional to a difference between an n-th percentile and a median of measured or predicted interference values over at least one period of time.

According to an embodiment of the sixth aspect, the condition may be inversely proportional to the period of the resource allocation messages.

According to an embodiment of the sixth aspect, the method may further comprise: transmitting, to the overlay network, a request for switching to the centralized interference management mode, in response to determining that received power of at least one reference signal from the overlay network meets a second condition.

According to an embodiment of the sixth aspect, the method may further comprise: switching to the centralized interference management mode, in response to receiving an acceptance message to the request for switching to the centralized interference management mode.

According to an embodiment of the sixth aspect, the method may further comprise: carrying out, in the centralized interference management mode, resource allocation based on the resource allocation messages received from the overlay network, and carrying out, in the distributed interference management mode, resource allocation and interference management based on local sensing on available frequency spectrum.

According to an embodiment of the sixth aspect, the method may further comprise providing a local subnetwork.

According to a seventh aspect, a computer program may comprise instructions for causing an apparatus to perform at least the following: determining a condition for a number of consecutively lost resource allocation messages transmitted periodically from an overlay network; receiving the resource allocation messages from the overlay network when in a centralized interference management mode; and switching to a distributed interference management mode, in response to detecting a number of consecutively lost resource allocation messages meeting the determined condition. The computer program may further comprise instructions for causing the apparatus to perform any embodiment of the method of the sixth aspect.

According to an eighth aspect, an apparatus may comprise means for determining a condition for a number of consecutively lost resource allocation messages transmitted periodically from an overlay network; means for receiving the resource allocation messages from the overlay network when in a centralized interference management mode; and means for switching to a distributed interference management mode, in response to detecting a number of consecutively lost resource allocation messages meeting the determined condition. The apparatus may further comprise means for performing any embodiment of the method of the sixth aspect.

Many of the attendant features will be more readily appreciated as they become better understood by reference to the following description considered in connection with the accompanying drawings.

### LIST OF DRAWINGS

FIG. 1 illustrates an example of a communication network, according to an example embodiment;

FIG. 2 illustrates an example of an apparatus configured to practice one or more example embodiments;

FIG. 3 illustrates an example of a procedure for switching from centralized interference management to distributed interference management, according to an example embodiment;

FIG. 4 illustrates an example of a flow chart for determining a condition for switching from centralized interference management to distributed interference management, according to an example embodiment;

FIG. 5 illustrates an example of operations at an access point for determining to switch from centralized interference management to distributed interference management, according to an example embodiment;

FIG. 6 illustrates an example of a procedure for switching from distributed interference management to centralized interference management, according to an example embodiment;

FIG. 7 illustrates an example of a method for enabling switching between centralized and distributed interference modes, according to an example embodiment; and

FIG. 8 illustrates an example of a method for switching between centralized and distributed interference modes, according to an example embodiment.

Like references are used to designate like parts in the accompanying drawings.

### DESCRIPTION

Reference will now be made to embodiments, examples of which are illustrated in the accompanying drawings. The description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Embodiments of the present disclosure may be applied for example in the context of short-range radio systems in order to support communication requirements for example in terms of throughput, latency, and/or reliability. Examples of such requirements may for example include multi-Gbps data rates or 100 μs latency with 99.9999999% reliability. Examples of such short-range radio systems include so called “in-X” cells or subnetworks, which may be configured for example according to sixth generation (6G) specifications of the 3rd generation partnership project (3GPP). For example, wireless isochronous real time (WIRT) in-X subnetworks may be provided for supporting fast closed-loop control. Such a local radio system may be described as a cell or a subnetwork. However, in general a subnetwork may comprise one or more cells that locally serve one or more client devices, for example sensors or actuators.

In-X subnetworks may be integrated with existing cellular infrastructure, for example to offload the most challenging services. The subnetworks may be configured to provide the same service level even when the subnetwork is out of coverage with respect to external network infrastructure. In-X subnetworks may be installed in entities such as for example robots, vehicles, production modules, or even human bodies, for the support of life critical operations. In the example of in-vehicle subnetwork, an in-X cell may be configured to replace a controller area network (CAN) bus or automotive Ethernet for various applications such as for example engine control, power steering, anti-lock braking system (ABS), or automated assisted driving. In the example of in-body subnetwork, the local cell may be used for example for streaming high quality virtual reality (VR) videos from a wristband to a headset, or to enable controlling and monitoring healthcare implants such as for example a wireless pacemaker or an insulin pump. A subnetwork may comprise a controller acting as an access point for a number of client devices, for example sensors or actuators, thereby forming to a short-range low-power cell. Range of such cell may be for example less than 10 m.

The use of in-X cells may provide a further leap to the concept of heterogenous networks (HetNets). An in-X cell may be for example connected to an external 3GPP network (e.g. an overlay network), which may be configured to control operations of the in-X cell or facilitate interference management (IM) among neighbouring in-X cells.

Since in-X cells may be installed at various mobile entities, the type of interference encountered at each use case may be different. For example, a vehicle may move very fast and therefore also the interference conditions may rapidly change. However, when in-X cells are provided at other type of entities, e.g., industrial robots or human bodies, the amount of interference may be potentially higher since robots or humans may sometimes gather around with dense populations. The interference level may be however less time-variant in such case. Another factor impacting the interference level is the distance to the external network infrastructure.

Interference management may be implemented in a centralized or distributed manner, depending on the technology. For example, 3GPP systems may be configured with centralized interference management solutions, where a hierarchy among macro/micro/pico/femto networks is defined. In centralized interference management, the different networks may be controlled externally, for example by pre-allocating orthogonal frequency spectrum chunks to each of the networks such that mutual interference is avoided. Also, inter-cell interference coordination (ICIC) comprising soft frequency reuse exploiting almost blank subframes and biasing may be applied.

Distributed interference management schemes may be applied for example for networks operating in the unlicensed spectrum. In distributed interference management, the different networks or devices are responsible of avoiding interference to other networks or devices. An example of a distributed interference coordination scheme operating in the time domain is carrier sense multiple access with collision avoidance (CSMA/CA), which exploits the listen before talk (LBT) procedure, which enables devices to make sure the relevant channel is free before they initiate transmission. Adaptive frequency hopping (FH) is another example of distributed interference coordination in the frequency domain. In the context of cognitive radio, several solutions for opportunistically reusing the spectrum unoccupied by incumbents may be applied, which provides a form of implicit coordination between incumbents and secondary access users. Examples of in X-cell environments with high probability to benefit from the distributed interference mode include sport centres and gyms, stadiums, busy city centres or roads, amusement parks, or the like.

In case of cellular communication networks, for example the device-to-device (D2D) communication system of 3GPP 5G New Radio (NR), two interference management modes may be applied: in Mode 1, transmission resource allocation is centralized and sidelink transmission resources may be scheduled by a base station; in Mode 2, the resource allocation is distributed and devices may coordinate their operations when out of coverage of a macro or micro network. However, as described above, the different in-X cell based deployment scenarios could benefit from a flexible interference management approach for seamlessly switching between different interference management modes. For example, it may be desired to enable the in-X cell to operate autonomously and switch to the distributed mode in a dynamic and flexible way.

It is therefore understood that networks employing local in-X type subnetworks may benefit from a flexible approach for interference management. Example embodiments of the present disclosure therefore provide enhanced interference management in-X cell scenario.

According to an example embodiment, an overlay network may transmit resource allocation messages periodically to an access point. The access point may switch to a distributed interference management mode, in response to detecting a number of consecutively lost resource allocation messages to meet a condition.

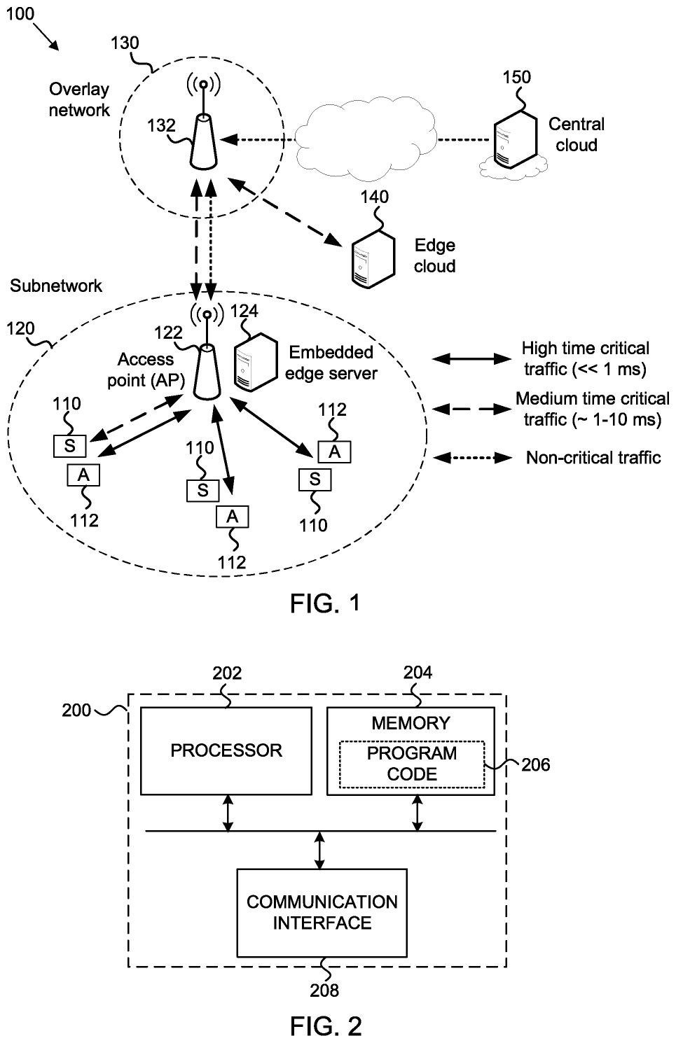

FIG. 1 illustrates an example of a communication network. The communication network 100 may comprise a subnetwork 120 having a connection to an overlay network 130. The overlay network 130 may for example comprise a wide area network (WAN) or an enterprise network. The overlay network 130 may comprise one or more base stations or access nodes 132, through which an access point 122 of the subnetwork 120 may access data processing services, for example an edge cloud 140 or a central could 150. The subnetwork may comprise an “in-X” subnetwork. The access point 122 may be installed at various type of devices, for example a mobile entity. The access point 122 may be therefore configured to provide a local (wireless) subnetwork at a mobile entity. The subnetwork 120 may be therefore referred to as a mobile subnetwork. The subnetwork 120 may comprise one or more cells (in-X cells). Each cell may be associated with one access point. The overlay network 130 may be configured to control a plurality of subnetworks, for example to perform centralized interference management among multiple subnetworks and/or cells.

The central cloud 150 may be configured to handle data processing for non-critical data, for which no strict latency requirements exist. The edge cloud 140 may be configured to handle data processing for medium time critical data. The subnetwork 120 may further comprise an embedded edge server 124, for example co-located with the access point 122. The subnetwork 120 may further comprise one or more devices (e.g. in-X devices) that are served by the access point 122. The devices may comprise for example sensor(s) 110 or actuator(s) 112. Network elements such as the base station(s) or access node(s) 132, the access point 122, may be generally referred to as network nodes or network devices. Although depicted as a single device, a network node may not be a stand-alone device, but for example a distributed computing system coupled to a remote radio head. For example, a cloud radio access network (cRAN) may be applied to split control of wireless functions to optimize performance and cost.

Such network configuration enables high critical data flows to be kept within the subnetwork, which enables to meet tight latency requirements that may not allow for external data processing. Medium critical data flows may be processed at the edge cloud 140 or an edge cloudlet. Multiple subnetworks may be connected to the overlay network 130 hosting such edge processing capabilities. The access point 122 may be configured to collect data and statistics on key performance indicators (KPIs), which may be shared outside the subnetwork 120 and for example processed at the central cloud 150. In this respect, the access point 122 may operate like a user equipment (UE) from the perspective of the cellular communication system (e.g. 6G). The access point 122 may for example access the overlay network 130 for traffic and/or control transmissions with medium or non-critical flows. The access point 122 may perform functions such as device-to-network relaying between the devices of the subnetwork 120 and the overlay network 130. Within the subnetwork 120, depending on the application scenarios, the access point 122 may be configured as a UE or a base station from the perspective of the devices of the in subnetwork 120.

Deployments of in-X cells are by nature uncoordinated and potentially dense. This may be the case, for example, with cells installed in vehicles in a crowded road, or cells installed in humans attending big events. As a consequence, the in-X cells may generate significant mutual interference. The operational resources may be managed by the external overlay network, for example a 3GPP macro network, which may assign for example orthogonal sub-bands to in-X cells operating in a same geographical region.

The access point 122 may be connected to the overlay network 130, for example to signal channel quality reports to the overlay network 130 and to receive information on the frequency resources to be used for the devices served by the access point 122. In-X cells may be expected to provide the required service level at any time and at any location where they are installed, for example when supporting life-critical services. Relying on connectivity to the overlay network 130 for managing the radio resources may not be therefore desired, since the in-X cells may be expected to preserve the service level even when out of coverage of the overlay network 130. In-X cells may be therefore configured to apply a distributed interference coordination scheme when out of coverage of the overlay network 130. The access point 122 does not therefore need to rely only on the overlay network 130 for interference management. A distributed interference management scheme may be based on exchange of messages among cells, or be fully implicit, i.e., only based on local sensing of the available frequency spectrum at the access point 122 for the sake of interference avoidance. Information about the available frequency spectrum may be for example preconfigured at the access point 122.

Centralized interference management may be however beneficial for example in terms of resource efficiency and energy consumption. It may be therefore desired to use the centralized interference management scheme whenever possible.

In future communication networks, such as for example 6G networks, a combination of machine learning (ML) and blockchain approach may be used, for example for decentralized network control. For example, in the context of D2D or V2X (vehicle-to-everything) communications and IoE (internet of everything), the distributed way of resource management and spectrum control may be considered as a potential solution. These techniques may be also applied in the context of the embodiments described herein. For example, the blockchain design may be used when the subnetwork 120 comprises more than one access point (cell).

6G is designed to apply ubiquitous computing. Ubiquitous computing is a concept where computing can occur using any device, in any location, and in any format. An apparatus using ubiquitous computing may be implemented in many different forms, for instance as a computer and/or communication means in everyday objects such as a refrigerator or a pair of glasses. Ubiquitous computing devices may be, for example wearable devices (including fabrics), hand-held devices, interactive larger display devices, miniaturized micro electro-mechanical systems (MEMS), etc. The computing may be implemented as an embedded system or by using application software

FIG. 2 illustrates an example of an apparatus 200, for example a computing device such as base station(s) or access node 132 or access point 122. Apparatus 200 may comprise at least one processor 202. At least one processor 202 may comprise, for example, one or more of various processing devices or processor circuitry, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware (HW) accelerator, a special-purpose computer chip, or the like.

Apparatus 200 may further comprise at least one memory 204. At least one memory 204 may be configured to store, for example, computer program code or the like, for example operating system software and application software. At least one memory 204 may comprise one or more volatile memory devices, one or more non-volatile memory devices, and/or a combination thereof. For example, at least one memory 204 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

Apparatus 200 may further comprise communication interface 208 configured to enable apparatus 200 to transmit and/or receive information to/from other devices. In one example, apparatus 200 may use communication interface 208 to transmit and/or receive signals, control messages, or the like. The communication interface may be configured to provide at least one wireless radio connection, such as for example a 3GPP mobile broadband connection (e.g. 3G, 4G, 5G, 6G). However, communication interface 208 may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection such as for example a local area network (LAN) connection, a universal serial bus (USB) connection or an optical network connection, or the like; or a wired Internet connection. The communication interface 208 may comprise, or be configured to be coupled to, at least one antenna to transmit and/or receive radio frequency signals. One or more of the various types of connections may be also implemented as separate communication interfaces, which may be coupled or configured to be coupled to one or more of a plurality of antennas.

Apparatus 200 may further comprise a user interface (not shown) comprising an input device and/or an output device. The input device may take various forms such a keyboard, a touch screen, or one or more embedded control buttons. The output device may for example comprise a display, a speaker, a vibration motor, or the like.

When apparatus 200 is configured to implement some functionality, some component and/or components of apparatus 200, such as for example at least one processor 202 and/or at least one memory 204, may be configured to implement this functionality. Furthermore, when at least one processor 202 is configured to implement some functionality, this functionality may be implemented using program code 206 comprised, for example, in at least one memory 204.

The functionality described herein may be performed, at least in part, by one or more computer program product components such as software components. According to an example, apparatus 200 comprises a processor or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), Graphics Processing Units (GPUs).

Apparatus 200 comprises means for performing at least one example described herein. In one example, the means comprises the at least one processor 202, the at least one memory 204 including program code 206 configured to, when executed by the at least one processor, cause the apparatus 200 to perform the example embodiment(s) described. Another example is that the operations described are carried out by computer program instructions running on means (for example 202, 204) which provide generic data processing functions. Such means can, for example, be embedded in a personal computer, smartphone, printer, vehicle, everyday object etc. The means may comprise radio transmitting and/or receiving means or the means carry out the data processing functions and use external radio head or like.

The apparatus 200 may comprise for example a computing or communication device such as for example a base station (or access node), a server, a network device, a wireless router, a mobile phone, a tablet computer, a laptop, a robot, an internet of things (IoT) device, or the like. Examples of IoT devices include, but are not limited to, consumer electronics, wearables, sensors, and smart home appliances. In one example, the apparatus 200 may comprise a vehicle such as for example a car. Although apparatus 200 is illustrated as a single device it is appreciated that, wherever applicable, functions of the apparatus 200 may be distributed to a plurality of devices, for example to implement example embodiments as a cloud computing service.

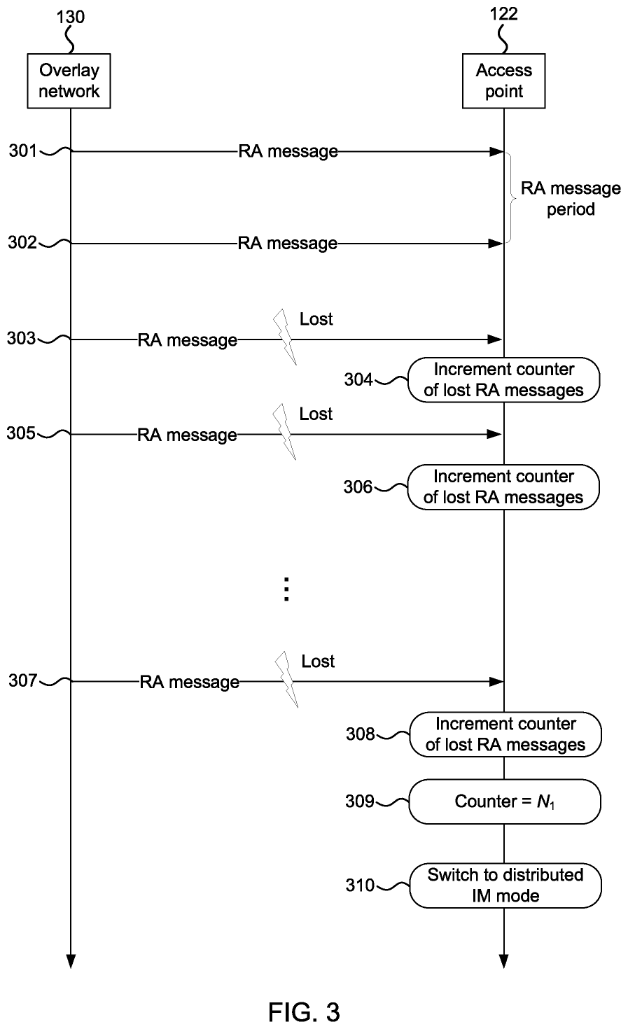

FIG. 3 illustrates an example of a procedure for switching from centralized interference management to distributed interference management. Initially access point 122 may operate in the centralized interference management mode. In centralized coordination of interference management, a network control entity of the overlay network 130 may be configured to perform interference management among multiple in-X cells. For example, in the centralized interference management mode, overlay network 130 may be configured to perform interference management for access point 122 and other access point(s). Overlay network 130 may transmit resource allocation (RA) messages periodically to access points of each in-X cell. Access point 122 may therefore carry out resource allocation based on the RA messages received from overlay network 130. Access point 122 may use the received resource allocation to control use of transmission resources when communicating with the devices served by access point 122, for example sensor(s) 110 and/or actuator(s) 112 of subnetwork 120.

Interference management may be performed in frequency, time, and/or spatial domains. However, transmission timing by centralized resource allocation may not be optimal for low latency services and spatial coordination solutions based on beamforming may not be desired in some applications due to potential limitation of the number of antennas. Interference management in frequency domain may include use of frequency reusing patterns, frequency hopping, and/or transmission power control, which may be based on interference measurements. Interference management algorithms may utilise for example tables, where transmission parameters are found by mapping based on interference measurement values.

To enable flexible switching between the interference management modes, access point 122 may for example implement a counter to switch from centralized interference management algorithms to distributed interference management algorithms. For example, access point 122 may switch to the distributed interference management mode, in response to determining that N₁ consecutive RA messages from overlay network 130 have been lost, as will be further described below with reference to operations 301 to 310.

At operation 301, overlay network 130 may transmit a first RA message to access point 122. The RA message may comprise information on transmission resources allocated to access point 122, for example one or more of: channel group (e.g. an index of a channel group), a frequency hopping factor, a frequency hopping pattern, or an upper limit for transmission power to be used by access point 122 or the devices coordinated by access point 122. Access point 122 may successfully receive the first RA message. Access point 122 may determine that a RA message is successfully received for example based on a cyclic redundancy check (CRC) code included in the RA message, or by any other suitable means.

At operation 302, overlay network 130 may transmit a second RA message. The RA messages may be transmitted periodically. A predetermined period of time (RA message period) may therefore exist between transmissions of consecutive RA messages. Based on the reception time of the previous RA message and the RA message period, access point 122 may determine expected reception time(s) of following RA message(s). An expected reception time may comprise a an expected reception time range to account for small variations in transmission and decoding latency. Each RA message may include resource allocation parameters similar to the first RA message. However, values of the RA parameters may be different, in order to enable dynamic interference management by overlay network 130. Access point 122 may successfully receive the second RA message.

At operation 303, overlay network 130 may transmit a third RA message. Based on the reception time of the second RA message and the RA message period, access point 122 may determine an expected reception time of the third RA message. If the third RA message is not successfully received, for example no message is received or a message is received erroneously at the expected reception time, access point 122 may determine that the third RA message was lost.

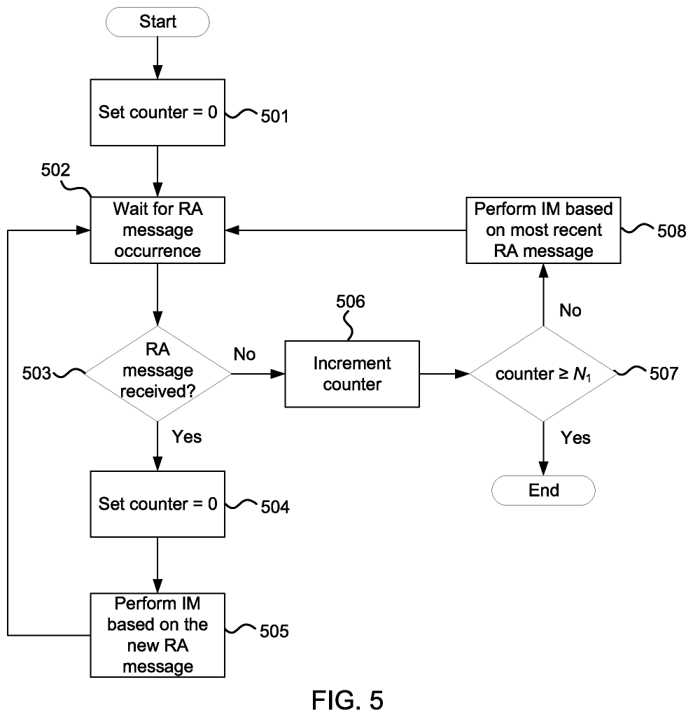

At operation 304, access point 122 may increment a counter of lost RA messages. The counter may be initially set to zero and re-initiated whenever a RA message is successfully received, as will be further described with reference to FIG. 5. The value of the counter may be therefore indicative of the number of consecutively lost RA messages. However, any other suitable implementation for keeping track of the number of consecutively lost RA messages may be applied.

At operation 305, overlay network 130 may transmit a fourth RA message. Based on the reception time of the second RA message and the RA message period (twice), the access point 122 may determine an expected reception time for the fourth RA message. If the fourth RA message is not successfully received at the expected time, access point 122 may determine that also the fourth RA message was lost.

At operation 306, access point 122 may increment the counter of lost RA messages, in response to determining that the fourth RA message was lost.

The procedure of incrementing the value of the counter may continue whenever another RA message is determined to be lost. Access point 122 may, before switching to the distributed interference management mode at operation 310, carry out resource allocation based on the latest successfully received RA message, in this example the second RA message of operation 302.

At operation 307, overlay network 130 may transmit another RA message, which access point 122 may determine to be lost and therefore the counter may be again incremented at operation 308.

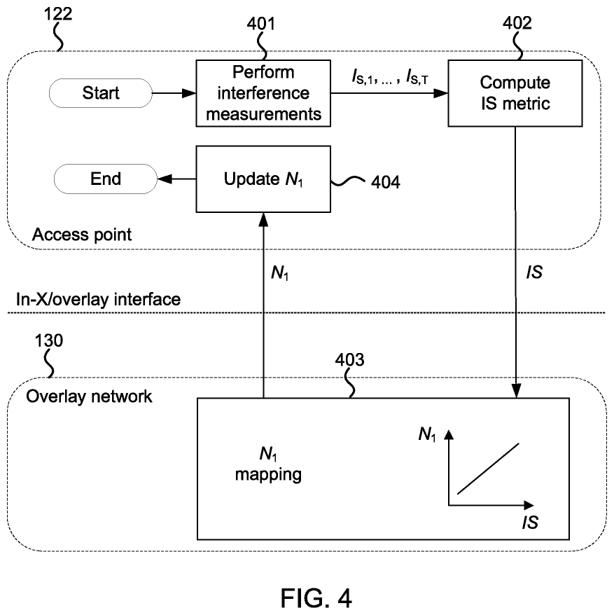

At operation 309, access point 122 may determine that the counter has reached, or alternatively exceeded, a threshold, N₁, for the number of consecutively lost RA messages. In general, access point 122 may determine whether a condition for the for the number of consecutively lost RA messages is met. The threshold, N₁, is an example of such condition. The threshold may be preconfigured at access point 122, determined by access point 122, or determined by overlay network 130 and signalled to access point 122, as will be further described below. Examples of the determination of the condition are explained in further detail by means of FIG. 4.

At operation 310, access point 122 may switch to the distributed interference management mode, in response to detecting the number of consecutively lost resource allocation messages to meet the condition, for example to reach (or exceed) the threshold. Switching to the distributed interference management mode may comprise initiating distributed interference management algorithm(s), for example CSMA/CA and/or frequency hopping algorithm(s), or in general local sensing of available frequencies to facilitate resource allocation such that interference to other in-X cells may be avoided.

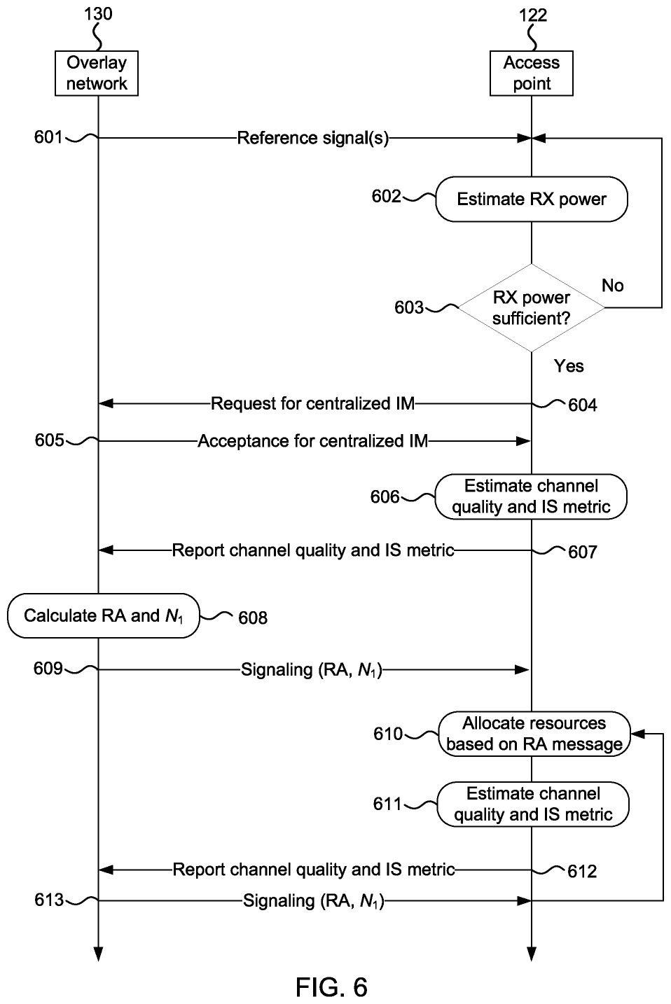

The procedure of FIG. 3 enables access point 122 to use the distributed interference management mode as a fall-back solution for the centralized interference management and therefore in-X cells are enabled to remain operational even out of coverage of overlay network 130, while benefiting from the more efficient interference management when being in coverage of overlay network 130. An example of a procedure for switching back to the centralized interference management mode is described with reference to FIG. 6.

FIG. 4 illustrates examples of determining a condition for switching from centralized interference management to distributed interference management. The condition may comprise the threshold, N₁, for the number of consecutively lost RA messages. The threshold may be determined based on stability of interference measured by access point 122. Interference stability may indicate the pace of interference level changes in the subnetwork at issue. Interference stability may be estimated based on history information on measured interference. Interference measurements may be performed by access point 122 in response to a specific request, for example on initial phase training of a machine learning (ML) algorithm, or as a part of normal operations in communication network 100. The history information of measured interference may be associated with a continuous time range, or alternatively the history information may be associated with discrete time chunks. For example, in some circumstances, such as for example on a road, the interference level may vary depending on the time of the day to the extent that it is beneficial to take the time of the day into consideration in interference management. The interference level may also vary in different weekdays, for example in case of amusement parks.

The value of the threshold, N₁, may be determined by a cooperative process between access point 122 and overlay network 130, as illustrated in FIG. 4. Overlay network 130 may determine N₁ based on a value of an interference stability (IS) metric calculated by access point 122 and reported to overlay network 130. Overlay network 130 may for example use a mapping function to map the estimated interference stability to N₁.

A rationale behind the mapping may be such that in case the in-X cell has experienced in the past stable interference conditions, and optionally is also foreseen to experience stable interference conditions also in the near future, the N₁ value may be set to be higher compared to the value of N₁ when the interference conditions are less stable. In stable interference conditions, the interference may be strong or weak, but rather stable. This means that the in-X cell may be able to tolerate a large number of losses of RA messages before switching to the distributed interference management mode, since the level of interference is expected to be stable and therefore the latest resource allocation information received from overlay network 130 may still be sufficiently valid.

Conversely, in case of a low interference stability metric, N₁ may be set to a low value. This is because the interference may vary significantly and therefore the information transmitted by overlay network 130 may become outdated sooner, forcing the in-X cell to rely on the distributed interference management mode earlier than in case of stable interference conditions. It is therefore pointed out that the value of N₁ may not be dependent on the magnitude of the interference, but rather on its past and/or predicted stability. An example of a procedure for determining N₁ is described below with reference to operations 401 to 404.

At operation 401, access point 122 may perform interference measurements. The interference measurements may be performed in any suitable manner to obtain a time series of measured interference values, for example in terms of interference power. The measured interference values may relate to a continuous time period or a set of discrete time periods (chunks), as described above, for example time periods comprising certain times of day, certain days of a week, or the like. For example, for time samples t=1,2, . . . , T the interference measurements may result in interference values I_{s,1}, . . . , I_{s,T}, where s refers to an index of the in-X cell in question.

At operation 402, access point 122 may compute a value of the interference stability (IS) metric. The value may be computed based on the interference values measured at operation 401.

Value(s) of the IS metric may be computed based on standard deviation of the measured interference values. Access point 122 may for example estimate the interference stability based on standard deviation of wideband (or sub-band) measured interference over the last T seconds. Wideband may refer to the full frequency band at which the subnetwork is configured to operate. A sub-band may be a portion of that frequency band. A large standard deviation may indicate high variability of the interference and may be therefore associated to a small value of the IS metric. On the other hand, small standard deviation may indicate that the interference is stable and therefore small standard deviation may be associated with a large value of the IS metric. The IS metric may be therefore inversely proportional to standard deviation of interference values measured over at least one period of time.

For example, access point 122 may estimate the standard deviation, σₛ, based on

$${σ}_{s} = \sqrt{\frac{1}{T} {\sum }_{t = 1}^{T} {I}_{s , t}} \qquad Equation ( 1 )$$

t=1,2, . . . , T is the time period (time samples) of the interference measurements
I_{s,t} is the measured interference value at cell s at time t

Access point 122 may then compute the value of the IS metric, IS_{σ,s}, for example based on

$${IS}_{σ , s} = \frac{{K}_{σ}}{{σ}_{s}} \qquad Equation ( 2 )$$

K_{σ} is an implementation-specific scaling factor
σₛ is the standard deviation

Equations (1) and (2) may be applied for example when computing the value of the interference metric based on wideband measured interference.

The value of the IS metric may be computed based on a difference between an n-th percentile and a median of the measured interference values. For example, the difference between the n-th worst, i.e. the strongest, percentile of the wideband (or subband) measured interference over the last T seconds, and its median value, may be used to compute the value of the IS metric. The n-th percentile may refer to an interference value, below which the given percentage n of the measured interference values are located. For example, the median value is 50^{th} percentile of the measured interference values. The value of n may be for example within the range of 90 to 99, for example 95.

This option may be better suited, (with the IS metric based on the n-th worst percentile), to some rare but troublesome interfering events. On the other hand, the standard deviation based option may in some cases provide better quality, since it may not be possible to estimate the percentiles (for the same time window length T) accurately enough to meet the quality the standard deviation based method.

Access point 122 may, before estimating the median and the n-th percentile, compute the cumulative distribution function (CDF) of the interference power. One approach to estimate the CDF of the interference power is to determine a histogram of the measured interference values. This approach may however not be optimal for a limited number of interference values. Therefore, other methods, such as for example Kernel density estimation, may be used to improve performance. Kernel density estimation provides an effective solution for estimating the CDF with low complexity.

In the Kernel density estimation, access point 122 may estimate the probability density function (PDF) of the measured interference values, f_{I}_{ₛ} (x), based on

$${f}_{{I}_{s}} ( x ) = \frac{1}{T} {\sum }_{t = 1}^{T} K ( x , {I}_{s , t} , γ ) , x \geq 0 \qquad Equation ( 3 )$$

t=1,2, . . . , T is the time period (time samples) of the interference measurements
K is a Kernel function
Iₛₜ is the measured interference value at cell s at time t
y is a smoothing factor which may be also referred to as a Kernel bandwidth
A Kernel function may comprise a weighting non-negative function used in non-parametric estimation techniques.

The cumulative distribution function, F_{I}_{ₛ}(x), of the measured interference values may be computed based on

$${F}_{{I}_{s}} ( x ) = {{\int }_{0}}^{x} {f}_{{I}_{s}} ( y ) dy , x \geq 0 \qquad Equation ( 4 )$$

and the value of the IS metric may be computed based on

$${IS}_{n - th , s} = \frac{{K}_{p}}{{F}_{{I}_{s}}^{- 1} ( n / 100 ) - {F}_{{I}_{s}}^{- 1} ( 0.5 )} \qquad Equation ( 5 )$$

Kₚ is an implementation-specific scaling factor
F_{I}_{ₛ}⁻¹ is an inverse of the cumulative distribution function of the measured interference values

The IS metric may be therefore inversely proportional to the difference between the n-th percentile and the median of the measured interference values. For example, considering the 95^{th} percentile, the value of the IS metric may be calculated by

$${IS}_{95 th , s} = \frac{{K}_{p}}{{F}_{{I}_{s}}^{- 1} ( 0.95 ) - {F}_{{I}_{s}}^{- 1} ( 0.5 )} \qquad Equation ( 6 )$$

Values for the standard deviation or the n-th percentile based IS metrics may be computed based on a prediction (future estimate) of interference values. In that case the time period t may extend to the future or contain merely future time samples. Computation of the IS metric may be otherwise similar. For example, Equations (1) and (2) or Equations (3) to (5) may be applied. The future interference values, e.g. an interference pattern, may be predicted using any suitable prediction technique, for example a Kalman filter or a recurrent neural network (RNN) taking as input a set of measured interference values. The prediction may be performed for a range of M seconds, which may be lower than T, and the value of the relevant IS metric may be calculated thereupon, optionally in combination with measured interference values.

Access point 122 may transmit the computed value of the IS metric to overlay network 130, for example over an in-X/overlay interface. The in-X/overlay interface may comprise a radio interface, for example an air interface of a cellular communication network (e.g. 6G). An indication of the value of the IS metric may be included for example in a control message.

At operation 403, overlay network 130 may determine the threshold, N₁, for the number of consecutively lost RA messages for access point 122 to switch to the distributed interference management mode. The threshold may be determined based on the value of the IS metric. Furthermore, the threshold may be dependent on, for example inversely proportional to, the RA message period (i.e. the period between RA messages). For example, a longer RA message period may result in a lower value of N₁, and vice versa. Mapping of the signalled value of the IS metric to N₁ may be for example based on a look-up table or a mapping function preconfigured at overlay network 130. The mapping function may for example comprise a linear mapping function, as illustrated in the example of FIG. 4. It is noted that while certain operations, such as for example transmission and reception of information between overlay network 130 and access point 122, may be performed by the base station(s) or access node(s) 132, other functionality, such as for example determination of N₁, may be implemented at any suitable network device or network function of overlay network 130.

At operation 403, overlay network 130 may further transmit an indication of the threshold, N₁, to the access point 122. Access point 122 may determine the condition or threshold by receiving the indication of the threshold from overlay network 130. In general, access point 122 may determine the condition for the number of consecutively lost resource allocation messages based on receiving information on the condition from overlay network 130.

At operation 404, access point 122 may update the value of the threshold. This enables the acceptable number of lost RA messages to be dynamically configured, which improves interference management in varying interference conditions.

In the example FIG. 4, the mapping of the value of the interference metric to the threshold, N₁, is performed by overlay network 130. Alternatively, access point 122 may determine the condition (e.g. the threshold) itself, without receiving information on the condition from overlay network 130. Access point 122 may determine the threshold similar to overlay network 130. For example, access point 122 may be preconfigured with a look-up table or a mapping function for this purpose. Alternatively, overlay network 130 may transmit the look-up table or the mapping function to access point 122. Access point 122 may receive the look-up table or the mapping function from overlay network 130.

Overlay network 130 may instruct the in-X cell on the type of IS calculation to be used, e.g. standard deviation of wideband interference or a gap (difference) between the n-th worst percentile and median interference, or on the type of look-up table to be used if the IS-to-N₁ mapping is done locally at the in-X cell. Overlay network 130 may therefore transmit an indication of a requested type of the IS metric to access point 122. The indication may comprise for example a signaling field in a control message, the signaling field comprising one or more bits whose values are indicative of the requested type of IS metric. For example, a first type of IS metric may be the standard deviation based IS metric. A second type may be the n-th percentile based IS metric. Similarly, overlay network 130 may transmit an indication of a requested type of look-up table or mapping function to access point 122. This enables overlay network 130 to control how access point 122 determines the threshold, N₁. Access point 122 is however still enabled to determine the threshold autonomously based on local interference measurements.

FIG. 5 illustrates an example of operations at an access point for determining to switch from centralized interference management to distributed interference management. This example illustrates the use of a counter in selection of interference management mode and RA parameters. The procedure may be implemented by an in-X cell when connected to overlay network 130, for example at access point 122.

At operation 501, access point 122 may initiate the counter, for example by setting the counter to zero (counter=0).

At operation 502, access point 122 may wait for a RA message occurrence, which may comprise an expected reception time of the next RA message, as described above.

At operation 503, access point 122 may determine whether a RA message was successfully received, for example based on a CRC field, as described above. If the RA message was not successfully received, i.e. the RA message was lost, access point 122 may transition to operation 506. If the RA message was successfully received, access point 122 may transition to operation 504.

At operation 506, the counter may be incremented by one (counter=counter+1).

At operation 507, access point 122 may determine whether the counter has reached or exceeded the threshold, N₁. If the counter has not reached or exceeded the threshold, access point 122 may transition to operation 508. If the counter has reached or exceeded the threshold, the procedure may be ended. Upon ending the procedure, access point 122 may switch to the distributed IM mode.

At operation 508, access point 122 may perform interference management based on the most recent successfully received RA message. Performing interference management may comprise performing resource allocation within the in-X cell according to the latest successfully received RA message. From operation 508 access point 122 may transition again to operation 502 to wait for another RA message occurrence.

At operation 504, access point 122 may re-initiate the counter, for example by setting it to zero (counter=0). As noted above, operation 504 may be entered in response to successful reception of a RA message. Therefore, from operation 504 access point 122 may transition to operation 505 to perform interference management based on the new RA message.

The above procedure enables access point 122 to maintain interference management functionality even out of coverage of overlay network 130, while considering stability of the interference when determining when to switch to the distributed interference management mode. The time spent in the centralized interference mode may be therefore increased.

FIG. 6 illustrates an example of a procedure for switching from distributed interference management to centralized interference management. Initially access point 122 may operate in the distributed interference management mode, for example after switching to it based on the procedure of FIG. 3 and/or FIG. 5. In the distributed interference management mode overlay network 130 may be configured not to perform interference management for access point 122 and other access point(s).

At operation 601, overlay network 130 may transmit reference signal(s) to access point 122. The reference signal(s) may comprise any suitable downlink reference signals, for example demodulation reference signals (DM-RS) or channel state information reference signals (CSI-RS). In general, a reference signal may comprise a signal that is known to the receiver, in this example access point 122.

At operation 602, access point 122 may estimate received (RX) power. Based on the reference signal(s) access point 122 may estimate RX power of the reference signal(s), which may be used as measure of the quality of the radio channel conditions to overlay network 130.

At operation 603, access point 122 may determine whether the RX power of the reference signal(s) is sufficient, for example above a second threshold. If the RX power is not sufficient, access point 122 may continue to receive further reference signal(s) and determine whether their power is sufficient. In case the RX power of the reference signal(s) is sufficiently high, reflecting a situation with sufficient coverage, access point 122 may move to operation 604.

At operation 604, access point 122 may signal to overlay network 130 a request to switch to the centralized interference management mode. For example, access point 122 may transmit, to overlay network 130, a request for switching to the centralized interference management mode, in response to determining at operation 603 that received power of the reference signal(s) received from the overlay network 130 meets a second condition, for example that the received power of the reference signal(s) is above the second threshold. Access point 122 may further transmit an indication of current level of interference and/or an indication of a level of requested transmission power to overlay network 130.

Overlay network 130 may receive the request. In case the request is received, overlay network 130 may then consider whether the switching is acceptable. For example, overlay network 130 may determine to accept the request for switching to the centralized interference mode based on the (current) level of interference and/or the requested transmission power reported by access point 122.

At operation 605, if the request is accepted, overlay network 130 may transmit an acceptance message for the switch to the centralized interference management mode. Access point 122 may switch to the centralized interference management mode, in response to receiving the acceptance. Access point 122 may then transition to operation 606. If the request is not accepted, overlay network 130 may transmit a declining message (non-acceptance message) to access point 122. If access point 122 receives the declining message, or in general if access point 122 does not receive the acceptance message, access point 122 may stay in the distributed interference management mode. For example, access point 122 may continue to carry out resource allocation independent of overlay network 130. Access point 122 may further continue to evaluate power of received reference signal(s) similar to operations 602 and 603.

At operation 606, access point 122 may estimate channel quality and IS metric. Estimating the channel quality may comprise interference measurements. An updated value of the IS metric may be determined based on the interference measurements and/or predicted interference measurement values, as described above.

At operation 607, access point 122 may report the channel quality and the IS metric. Access point 122 may therefore continue reporting of interference measurements to the overlay network 130, in response to the switch to the centralized interference management mode. As described above, the reporting of interference measurements may be ceased upon entry to the distributed interference management mode. Access point 122 may further transmit an indication of the updated value of the IS metric to overlay network 130.

At operation 608, overlay network 130 may perform interference management by determining an updated resource allocation for access point 122.

Overlay network 130 may further determine an updated threshold (N₁) to be used by access point 122 when determining whether to switch to the distributed interference management mode again. The updated resource allocation may be determined based on the current level of interference, which may be reported to overlay network 130 by access point 120, for example at operation 607. The updated threshold (N₁) may be determined based on the updated value of the IS metric.

At operation 609, overlay network 130 may transmit an indication of the updated resource allocation and the updated threshold, N₁, to access point 122. This information may be transmitted using any suitable signaling, for example a control message. Access point 122 may receive the updated resource allocation. Access point 122 may receive the updated threshold. Alternatively, access point 112 may determine the updated threshold itself, in which case N₁ may not be calculated by the overlay network 130 nor transmitted to access point 122 by overlay network 130.

At operation 610, access point 122 may carry out resource allocation based on the updated resource allocation. Access point 122 may also reconfigure determination of switching to the distributed interference management mode to apply the updated threshold, N₁.

At operations 611 and 612, access point 122 may again estimate and report the channel quality and the value of the IS metric, similar to operations 606 and 607, which may result in another updated resource allocation and another updated threshold to be received from the overlay network 130 at operation 613. In response to receiving the updated signalling (RA, N₁), access point 122 may return to operation 610 to carry out resource allocation, as indicated by the arrow.

Example embodiments of the present disclosure therefore enable flexible switching between centralized and distributed interference management modes and dynamic reconfiguration of parameters associated therewith.

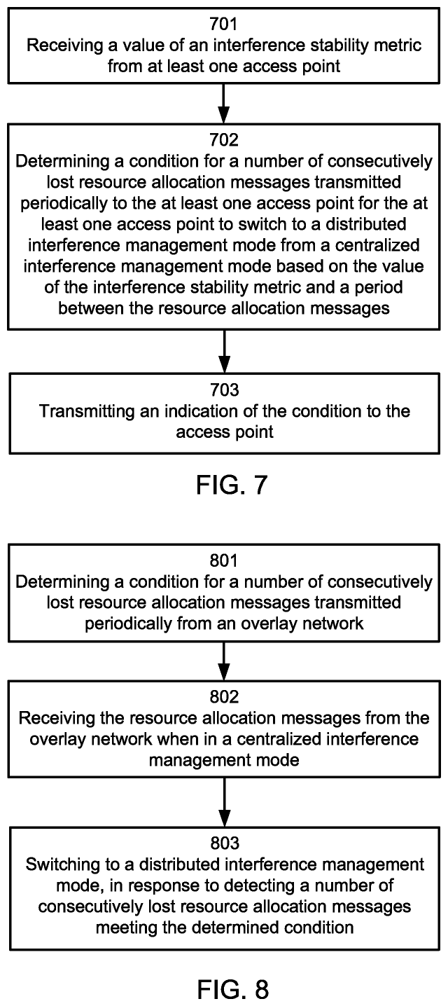

FIG. 7 illustrates an example of a method for enabling switching between centralized and distributed interference modes.

At 701, the method may comprise receiving a value of an interference stability metric from at least one access point.

At 702, the method may comprise determining a condition for a number of consecutively lost resource allocation messages transmitted periodically to the at least one access point for the at least one access point to switch to a distributed interference management mode from a centralized interference management mode based on the value of the interference stability metric and a period between the resource allocation messages.

At 703, the method may comprise transmitting an indication of the condition to the access point.

FIG. 8 illustrates an example of a method for switching between centralized and distributed interference modes, according to an example embodiment.

At 801, the method may comprise determining a condition for a number of consecutively lost resource allocation messages transmitted periodically from an overlay network.

At 802, the method may comprise receiving the resource allocation messages from the overlay network when in a centralized interference management mode.

At 803, the method may comprise switching to a distributed interference management mode, in response to detecting a number of consecutively lost resource allocation messages meeting the determined condition.

Examples of the methods are explained above with regard to functionalities and parameters of overlay network 130 or access point 122, and are not repeated here.

It should be understood that embodiments described may be combined in different ways unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1-23. (canceled)

24. An apparatus, comprising:
at least one processor; and
at least one memory including computer program code, the at least one memory and the computer code configured to, with the at least one processor, cause the apparatus at least to:
receive a value of an interference stability metric from at least one access point;
determine a condition for a number of consecutively lost resource allocation messages transmitted periodically to the at least one access point for the at least one access point to switch to a distributed interference management mode from a centralized interference management mode based on the value of the interference stability metric and a period between the resource allocation messages; and
transmit an indication of the condition to the access point.

25. The apparatus according to claim 24, wherein the condition is inversely proportional to the period between the resource allocation messages.

26. The apparatus according to claim 24, wherein the at least one memory and the computer code are further configured, with the at least one processor, to cause the apparatus to:
transmit an indication of a requested type of the interference stability metric to the access point.

27. The apparatus according to claim 24, wherein the at least one memory and the computer code are further configured, with the at least one processor, to cause the apparatus to:
transmit an indication of a requested type of the interference stability metric to the access point, and wherein the interference stability metric is inversely proportional to a standard deviation of measured or predicted interference values over at least one period of time, or wherein the interference stability metric is inversely proportional to a difference between an n-th percentile and a median of the measured or predicted interference values over the at least one period of time.

28. The apparatus according to claim 24, wherein the at least one memory and the computer code are further configured, with the at least one processor, to cause the apparatus to:
transmit the resource allocation messages periodically to the access point; and
in the case a request for switching to the centralized interference management mode is received, consider whether the switching is acceptable based on a level of interference reported by the access point and/or transmission power requested by the access point.

29. The apparatus according to claim 24, wherein the at least one memory and the computer code are further configured, with the at least one processor, to cause the apparatus to:
transmit the resource allocation messages periodically to the access point; and in the case a request for switching to the centralized interference management mode is received, consider whether the switching is acceptable based on a level of interference reported by the access point and/or transmission power requested by the access point, and wherein the at least one memory and the computer code are further configured, with the at least one processor, to cause the apparatus to:
determine to accept the request for switching to the centralized interference mode; and
transmit an acceptance message for the request for switching to the centralized interference mode to the access point.

30. The apparatus according to claim 24, wherein in the centralized interference management mode the apparatus is configured to perform interference management for the access point and one or more other access points, and wherein in the distributed interference management mode the apparatus is configured not to perform interference management for the access point and the one or more other access points.

31. The apparatus according to claim 24, wherein the access point is configured to provide a local subnetwork.

32. An apparatus, comprising:
at least one processor; and
at least one memory including computer program code, the at least one memory and the computer code configured to, with the at least one processor, cause the apparatus at least to:
determine a condition for a number of consecutively lost resource allocation messages transmitted periodically from an overlay network;
receive the resource allocation messages from the overlay network when in a centralized interference management mode; and
switch to a distributed interference management mode, in response to detecting a number of consecutively lost resource allocation messages meeting the determined condition.

33. The apparatus according to claim 32, wherein the at least one memory and the computer code are further configured, with the at least one processor, to cause the apparatus to:
carry out, before the switching to the distributed interference management mode, resource allocation based on a latest successfully received resource allocation message.

34. The apparatus according to claim 32, wherein the at least one memory and the computer code are further configured, with the at least one processor, to cause the apparatus to:
determine a value of an interference stability metric; and
determine the condition based on the value of the interference stability metric and a period of the resource allocation messages, or
transmit the value of the interference stability metric to the overlay network and receive information on the condition from the overlay network.

35. The apparatus according to claim 32, wherein the at least one memory and the computer code are further configured, with the at least one processor, to cause the apparatus to:
determine a value of an interference stability metric; and determine the condition based on the value of the interference stability metric and a period of the resource allocation messages, or transmit the value of the interference stability metric to the overlay network and receive information on the condition from the overlay network, and wherein the interference stability metric is inversely proportional to a standard deviation of measured or predicted interference values over at least one period of time, or wherein the interference stability metric is inversely proportional to a difference between an n-th percentile and a median of measured or predicted interference values over at least one period of time.

36. The apparatus according to claim 32, wherein the at least one memory and the computer code are further configured, with the at least one processor, to cause the apparatus to:
determine a value of an interference stability metric; and determine the condition based on the value of the interference stability metric and a period of the resource allocation messages, o transmit the value of the interference stability metric to the overlay network and receive information on the condition from the overlay network, and wherein the condition is inversely proportional to the period of the resource allocation messages.

37. The apparatus according to claim 32, wherein the at least one memory and the computer code are further configured, with the at least one processor, to cause the apparatus to:
determine a value of an interference stability metric; and determine the condition based on the value of the interference stability metric and a period of the resource allocation messages, o transmit the value of the interference stability metric to the overlay network and receive information on the condition from the overlay network, and wherein the at least one memory and the computer code are further configured, with the at least one processor, to cause the apparatus to:
transmit, to the overlay network, a request for switching to the centralized interference management mode, in response to determining that received power of at least one reference signal from the overlay network meets a second condition.

38. The apparatus according to claim 32, wherein in the centralized interference management mode the apparatus is configured to carry out resource allocation based on the resource allocation messages received from the overlay network, and wherein in the distributed interference management mode the apparatus is configured to carry out resource allocation and interference management based on local sensing on available frequency spectrum.

39. The apparatus according to claim 32, wherein the apparatus is configured to provide a local subnetwork.
